(19) United States
(12) Patent Application Publication
(10) Pub. No.: US 2026/0326784 A1
(43) Pub. Date: Oct. 22, 2026

(54) MULTI-LAYERED AIR COVERAGE FOR AUTONOMOUS DRIVING

(71) Applicant: AUTOBRAINS TECHNOLOGIES LTD, Tel Aviv-Yafo (IL)

(72) Inventors: Igal RAICHELGAUZ, Tel Aviv (IL); Shani NEHAMA, Afek (IL)

(73) Assignee: AUTOBRAINS TECHNOLOGIES LTD, Tel Aviv-Yafo (IL)

(21) Appl. No.: 19/181,370

(22) Filed: Apr. 17, 2025

(51) Int. Cl. B60W 60/00

(52) U.S. Cl. CPC B60W 60/001; B60W 2556/45

(57) ABSTRACT

A method of autonomous driving, that allocates more aerial resources when a road scenario deviation According to an embodiment, the method includes obtaining, at a computerized system in real-time, sensed ground data holding road object information of road objects of a region of view; processing, at a machine learning process of the computerized system, the sensed ground data in accordance with road object information samples collected at different points of time across the region of view; determining, based on the processing, an occurrence of a road scenario deviation pertaining to the region of view; and selectively applying, in real-time in accordance with the identified occurrence of the road scenario deviation, an air coverage operation across the region of view, for use in autonomous driving in, at least in part, the region of view.

### BACKGROUND

Ground vehicles have a limited field of view that may provide very limited assistance when a road scenario deviation occurs. Aerial systems may provide more information, but the accessibility of aerial system is limited for various reasons including safety reasons (for example limitation on the number of aerial systems per dense urban areas, drone no fly zones, and the like) and for cost reasons that allocate a small number of aerial systems per large regions.

There is growing need to provide a cost effective and improved coverage in cases of a road scenario deviation.

### SUMMARY

There is provided a method, a non-transitory computer readable medium and a system as illustrated in the application.

### BRIEF DESCRIPTION OF THE DRAWINGS

The embodiments of the disclosure will be understood and appreciated more fully from the following detailed description, taken in conjunction with the drawings in which:

FIG. 1 illustrates an example of a computerized system;

FIG. 2 illustrates an example of a vehicle;

FIG. 3 illustrates an example of a method;

FIG. 4 illustrates an example of a region with or without a road scenario deviation;

FIG. 5 illustrates an example of an area that includes the region of FIG. 4;

FIG. 6 illustrates an example of multiple areas that include the area of FIG. 5;

FIG. 7 illustrates an example of a method;

FIG. 8 illustrates an example of a method;

FIG. 9 illustrates example of regions, a map, and a patch; and

FIG. 10 illustrates an example of a method.

### DETAILED DESCRIPTION

The different figures illustrates examples of units and/or software and/or information items and/or steps and/or components. These examples are provided for brevity of explanation. At least one of the units and/or software and/or information items and/or steps and/or components is optional or mandatory.

The term obtaining include receiving and/or generating.

Artificial intelligence is used in relation to machines that mimic human intelligence and human cognitive functions like learning and problem solving. There are three types of artificial intelligence that include artificial super intelligence, artificial narrow intelligence and artificial general intelligence. Machine learning is a subset of artificial intelligence that allows for optimization. Deep machine learning is a subset of machine learning that uses larger datasets for training and learns in a different manner than not deep machine learning. Neural networks are a subset of machine learning and are used for implementing deep learning.

Any reference in the application to any of the terms "artificial intelligence", "machine learning", "deep learning" or "neural network" should be applied mutatis mutandis to any other term of "artificial intelligence", "machine learning", "deep learning" or "neural network". For example - any reference to a neural network should be applied mutatis mutandis to artificial intelligence and/or should be applied mutatis mutandis to "machine learning", and/or should be applied mutatis mutandis to "deep learning".

Any reference to information should be applied mutatis mutandis to one or more parts of the information.

According to an embodiment, there is provided a method for multi-layered for air coverage for use in autonomous driving. The method provides for selectively applying, in real-time, an air coverage operation across a region of view typically associated with a road scenario deviation. The air coverage operation may include allocating, or prompting allocation of an aerial resource or an aerial system in the environment of a road scenario deviation, once the road scenario deviation is identified on the road. As such, the air coverage operation provides multi-level air coverage by providing, in real-time, sensed aerial data to one or more vehicles on the road for use in perception and path planning of autonomous driving, at least in part in the region of view associated with the identified road scenario deviation.

A non-transitory computer readable medium for multi-layered air coverage for autonomous driving is also provided. The non-transitory computer readable medium stores instructions that, when executable by at least one processing device, cause the processing device to obtain in real-time, sensed ground data holding road object information of road objects of a region of view; and process, at a machine learning process of the computerized system, the sensed ground data in accordance with road object information samples collected at different points of time across the region of view. The non-transitory computer readable medium further stores causing the processing device to identify, based on the processing, an occurrence of a road scenario deviation pertaining to the region of view; and selectively apply, in real-time in accordance with the identified occurrence of the road scenario deviation, an air coverage operation across the region of view, for use in autonomous driving in, at least in part, the region of view.

The air coverage operation may include issuing an instruction to a computerized system of the aerial system to provide aerial information across the road scenario deviation in the region of view.

The stored instructions may further cause the processing device to process, by a processing circuit, the aerial information; and determine, based on the processed aerial information, a path of driving for autonomous driving of a vehicle in the occurrence of the road scenario deviation.

The stored instructions may cause the processing device to selectively apply the air coverage operation by invoking extraction of aerial data pertaining to the region of view.

The stored instructions may cause the processing device to obtain the sensed ground data from one or more road vehicles in the region of view.

The stored instructions may cause the processing device to obtain the sensed ground data from a navigation system being in communication with the computerized system.

The stored instructions may cause the processing device to obtain the sensed ground data from a street view system.

The stored instructions may cause the processing device to selectively apply the air coverage operation further in accordance with a teleoperation control system associated with the computerized system.

A system for multi-layered air coverage for autonomous driving is also provided. The system comprising a memory configured to store sensed ground data holding road object information of road objects of a region of view. The system also comprises a processor configured to process, in real-time at a machine learning process, the sensed ground data in accordance with road object information samples collected at different points of time across the region of view; and identify, based on the processed sensed ground data, an occurrence of a road scenario deviation pertaining to the region of view. The processor is further configured to selectively apply, in real-time in accordance with the identified occurrence of the road scenario deviation, an air coverage operation across the region of view, for use in autonomous driving in, at least in part, the region of view.

According to an embodiment, the method includes obtaining, at a computerized system in real-time, sensed ground data holding road object information of road objects of a region of view; processing, at a machine learning process of the computerized system, the sensed ground data in accordance with road object information samples collected at different points of time across the region of view; identifying, based on the processing, an occurrence of a road scenario deviation pertaining to the region of view; and selectively applying, in real- time in accordance with the identified occurrence of the road scenario deviation, an air coverage operation across the region of view, for use in autonomous driving in, at least in part, the region of view.

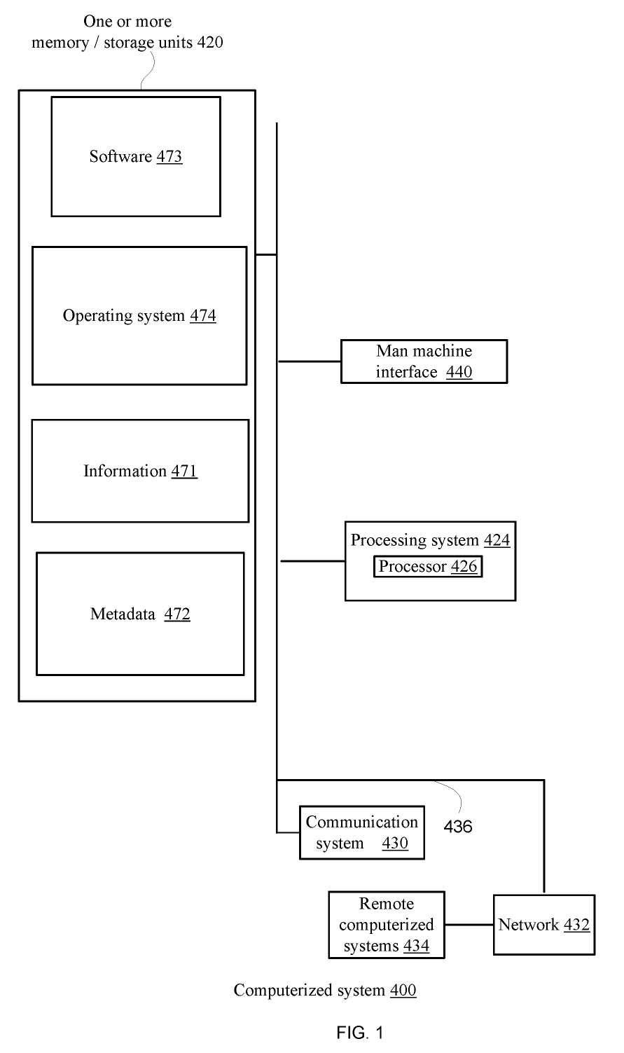

FIG. 1 illustrates an example of a computerized system 400.

Computerized system 400 includes a man machine interface 440 having or being in communication with man machine interface (MMI) controller (not shown), a communication system 430, one or more memory and/or storage units 420, a processing system 424 including processor 426. The computerized system may be a server, a laptop, a desktop or any other computer and may include or be in communication with a sensing unit and/or a controller.

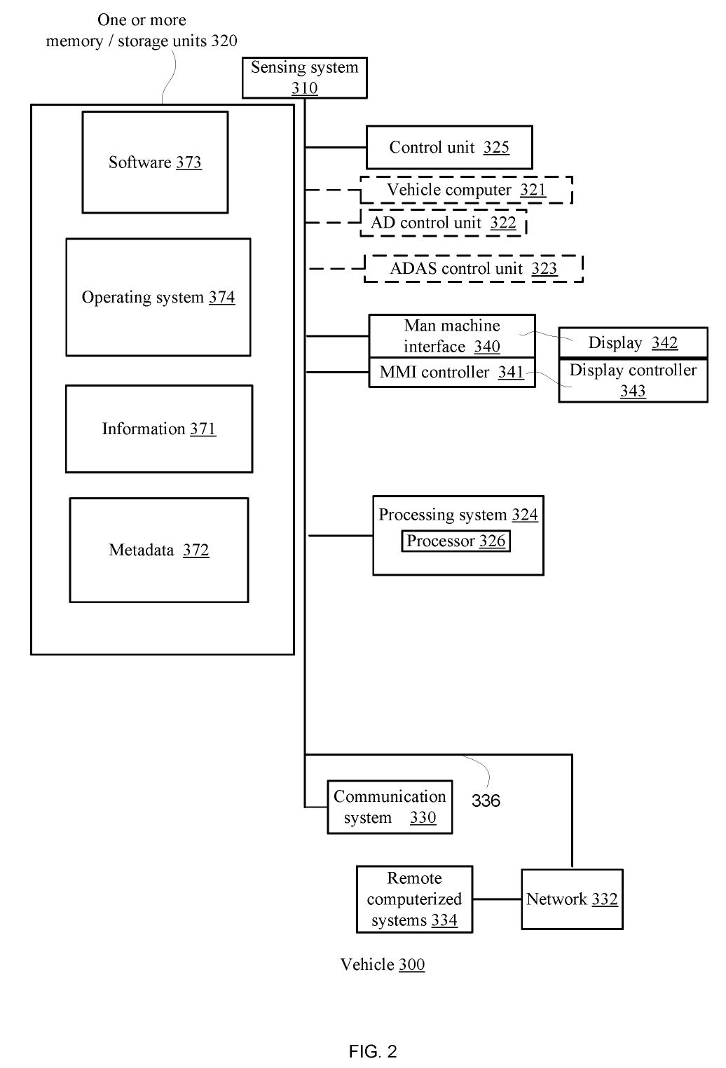

According to an embodiment, computerized system 400 is in communication with network 432 and one or more other remote computerized systems 434 that are in communication with network 432. An example of a remote computerized system is a vehicle (such as vehicle 300 of FIG. 2), a server or one or more computers having access to a storage system.

The memory and/or storage units 420 was shown as storing software. Any reference to software should be applied mutatis mutandis to code and/or firmware and/or instructions and/or commands, and the like.

Processor 426 includes a plurality of processing units 426(1)- 426(J), J is an integer that exceeds one. Any reference to one unit or item should be applied mutatis mutandis to multiple units or items. For example - any reference to processor should be applied mutatis mutandis to multiple processors, any reference to communication system 430 should be applied mutatis mutandis to multiple communication systems.

According to an embodiment, the memory and/or storage units 420 stores at least one of: operating system 474, information 471, metadata 472, and software 473.

According to an embodiment, processing system 424 is configured to perform any method illustrated in the application while executing software.

FIG. 2 illustrates an example of vehicle 300 configured to utilize the set of artificial intelligence models during inference.

Vehicle 300 includes a man machine interface 340 having or being in communication with man machine interface (MMI) controller 341, wherein in FIG. 1 the MMI is a display 342 or includes a display 342 and the MMI controller is a display controller 343 or includes the display controller 343, a communication system 330, one or more memory and/or storage units 320, a processing system 324 including processor 326 . The communication system 330, the one or more memory and/or storage units 320, and the processing system 324 may belong to a computerized system of vehicle 300. The computerized system may be a server, a laptop, a desktop or any other computer and may include or be in communication with a sensing unit and/or a controller.

According to an embodiment the processing system implements an artificial intelligence model for driving. The artificial intelligence model may be used in relation to generating and/or requesting and/or determining and/or instructing and/or triggering and/or controlling and/or transmitting and/or outputting and/or preforming at least one autonomous or non-autonomous driving related operation is associated with the artificial intelligence models below a maturity level, and/or driving along the path - for example in compliant with one or more levels of autonomous driving - such as L2, L2+, L2++, L3 or L4 autonomous driving.

According to an embodiment, vehicle 300 is in communication with network 332 and one or more other remote computerized systems 334 that are in communication with network 332. An example of a remote computerized system is a server or one or more computers having access to a storage system that stores items related to one or more portions of one or more groups of neural networks - at least some of which are not currently stored in the vehicle.

According to an embodiment, the memory and/or storage unit 320 stores at least one of: operating system 374, information 371, metadata 372, and software 373.

The control unit 325 may cooperate with ADAS control unit 323 and/or with AD control unit 322 and/or may control or communicate with other vehicle components - including vehicle computer.

The ADAS control unit 323 is configured to control ADAS operations.

The AD control unit 322 is configured to control autonomous driving of the autonomous vehicle.

The vehicle computer 321 is configured to control the operation of the vehicle - especially controlling the engine, the transmission, and any other vehicle system or component.

The vehicle computer 321 may be in communication with an engine control module, a transmission control module, a powertrain control module, and the like.

According to an embodiment, the processing system is configured to generate a driving related decision and/or implement the driving related decision.

Examples of generating a driving related decision are provided in at least one patent out of US patent 12128927 which is incorporated herein by reference, and/or US patent 11897497 which is incorporated herein by reference. While said patent refers to a school zone its teaching can be applied mutatis mutandis to any other road scenarios.

According to an embodiment, the driving related decision is converted to instructions and/or commands and/or requests to move the vehicle according to the driving pattern.

According to an embodiment, the driving related decision includes instructions and/or commands and/or requests to move the vehicle according to the driving pattern.

According to an embodiment, any driving related decision generated by the processing system and/or by the computerized system of FIG. 1 and transmitted to vehicle 300 may include or may be converted to (by a computerized system of the vehicle or by another computerized system) a request and/or a determining of an instruction and/or an instruct and/or a trigger and/or a control of and/or a performance of an autonomous driving related operation of the vehicle. The driving related decision may be related to a velocity and/or acceleration and/or direction of movement of the ground vehicle at one or more points in time. According to an embodiment, the driving related decision is aimed at one or more vehicle components such as brakes, clutch, engine, gear, or any other component that sets the velocity and/or acceleration and/or direction of movement of the ground vehicle.

According to an embodiment, any driving related decision generated by any computerized system is in compliant with one or more levels of autonomous driving - such as L2, L2+, L2++, L3 or L4 autonomous driving.

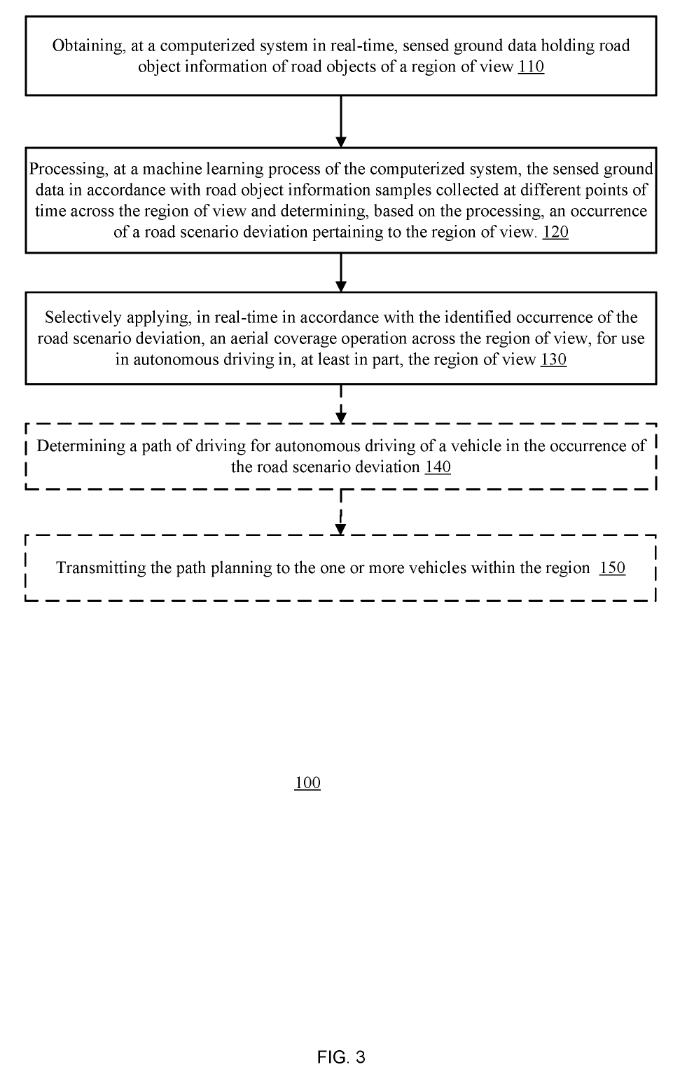

FIG. 3 illustrates an example of method 100. According to an embodiment, method 100 is for multi-layered air coverage for autonomous driving.

According to an embodiment, method 100 includes step 110 of obtaining, at a computerized system in real-time, sensed ground data holding road object information of road objects of a region of view. An example of a computerized system is computerized system 400 of FIG. 1.

According to an embodiment, the sensed ground information is sensed by one or more road vehicles in the region of view.

According to an embodiment, the sensed ground information is distributed and/or transmitted using one or more types of information such as but not limited to a vehicle to vehicle (v2v) system, or vehicle to everything communication (V2E), local area communication, large area communication, the internet, one or more wireless communication, and the like.

According to an embodiment, the region of view is populated with multiple vehicle and each vehicle independently transmits the sensed ground data towards the computerized system. In an example, such transmission may be enabled using (at least) cellular network communication.

According to an embodiment, the communication takes into account possible cellular communication disruption following the occurrence of one or more types of road scenario deviation - such as road scenario deviations that involve a high density and/or a high number of ground vehicle per cellular cell. According to an embodiment, the ground vehicles, when sensing cellular communication failures (or when estimating such failures - for example when sensing a traffic jam or sensing a fire, or another hazard) - are configured to use one or more alternative communication protocols - such as more local solutions (for example vehicle to vehicle communication, wi-fi communication and the like) or satellite communication to convey the sensed ground information.

In some cases, the computerized system identifies or estimates that one or more types of a road scenario deviation occurs, or is about to occur. The identified road scenario deviation can be any deviation from a road scenario that is known, or familiar to the system, such as a road scenario deviation that involves a high density and/or a high number of ground vehicle per cellular cell, or a different distribution of ground vehicles on the ground.

The computerized system then selectively applies an air coverage operation in accordance with the road scenario deviation identified. In an example, the computerized system issues an alert or notification, or an instruction to the vehicles on the ground within the region of the road scenario deviation prompting the ground vehicle to use communication protocols that may overcome cellular communication problems.

Identifying the road scenario deviation may involve an estimation or prediction that is based on time and locations - for example estimating an occurrence of a traffic jam at an unpredicted time of day in an unexpected location, or identifying a traffic jam at a highly popular location.

In some cases, the computerized system is configured to identify a road scenario deviation with respect to a particular road feature, or to a change in a particular road feature on the ground. The road feature may be a road marking, roundabout, traffic light, traffic sign, and others.

The identified road scenario deviation may be associated with a change in a particular road feature on the ground, like identified one or more new, or to a change in an existing road feature on the ground. In such case, the identified road deviation pertains to identification of one or more new road features on the ground, which have not been there before, or to identification of a change of a metric of one or more road features, which have been there before but include a change of any type or form, such as change of classification, or change of location, or change of position, or change of size, or other.

The particular new road feature, or a change in an existing road feature can also make up the identified road scenario deviation.

For example, the road features associated with an identified road scenario deviation may include a new marking on the road, a change in an existing road marking on the road, an occurrence of a new roundabout, of a new traffic sign, an absence of a particular traffic sign, or road marking, and other.

The computerized system may be configured to download, or trigger a download operation of air based data, air based imagery, aerial based data, a satellite image, SAR based data, and/or other type of aerial image such as for example captured by an aerial system like a drone, holding aerial information about the one or more road features associated with the identified road scenario deviation. The computerized system can trigger one or more vehicles to download the satellite image, for updating its stored images and mapping information stored internally in the system of the vehicle, or held in association, for example in the cloud, with the driving system of the vehicle.

The computerized system may further process an existing satellite image, or map information, pertaining to the one or more road markings that make up the road scenario deviation.

The processing may involve incorporating the change to the one or more road features associated with the road scenario deviation.

Incorporating a new road feature, or a change in an existing road feature, in existing satellite images or mapping information may involve updating the object lists held in a memory of the system of the vehicle with object list information holding information pertaining to the new road feature, or to the change of metrics in an existing road feature.

In such case, there is no need for downloading new satellite images, or for downloading additional aerial information from an aerial system. Incorporating the change in road features renders the need to download satellite images, and/or to download and update additional aerial information from the cloud.

According to an embodiment, the computerized system is configured to process the information transmitted in relation to an identified road scenario deviation, including information related to a current or future occurrence of a road scenario deviation.

The computerized system may be configured to process the transmitted information with respect to the road scenario deviation and/or further in accordance with the air coverage operation. The processing may include compressing the information, incorporating the information, or a portion of the information like that relating to a region of interest only or to a specific road feature on the ground, in existing satellite or mapping images stored for example in the cloud, extracting specific patches of information from the overall transmitted information of the image, scaling the transmitted information in a particular manner, positioning the data in a particular manner, applying an orientation operation to the data of the transmitted information, and other operations.

It may be the case, that the system in the one or more vehicles is configured to compress the information transmitted in relation to the current or future occurrence of a road scenario deviation.

According to an embodiment, the compression includes reducing resolution of the sensed ground information, transmitting information pertaining to a particular region of interest only, or transmitting black and white images only, and not color images.

According to an embodiment, the compressions includes converting sensed ground information to textual information regarding the environment of the vehicle (for example an object list), sensing mostly or only location information of other vehicles and/or sensing only or mostly locations and speed of other objects, sending only or mostly speed and location of the ego vehicle.

According to an embodiment, both compression and the usage of non-cellular communication are used.

According to an embodiment, the vehicles within the region of the road scenario deviation share with each other information regarding the availability of cellular information and/or the available communication bandwidth they have. The communication is directed between the vehicles of the region to the one or more vehicles that have access to cellular communication and/or have higher available communication bandwidth.

According to an embodiment, step 110 includes receiving the sensed ground information from one or more navigation systems, or navigation software like waze, being in communication with the computerized system.

According to an embodiment, step 110 includes receiving the sensed ground information from one or more street view systems.

According to an embodiment, step 110 includes receiving the sensed ground information from a source that differs from the one or more vehicles.

According to an embodiment, a road scenario incorporates multiple aspects of and metrics affecting implementation of a model for autonomous driving, including for example a location of the vehicle, one or more weather conditions, one or more contextual parameters, road condition, traffic parameter(s). Various examples of a road condition may include the roughness of the road, the maintenance level of the road, presence of potholes or other related road obstacles, whether the road is slippery, covered with snow or other particles. Various examples of a traffic parameter and the one or more contextual parameters may include time (hour, day, period or year, certain hours at certain days, and the like), a traffic load, a distribution of vehicles on the road, the behavior of one or more vehicles (aggressive, calm, predictable, unpredictable, and the like), the presence of pedestrians near the road, the presence of pedestrians near the vehicle, the presence of pedestrians away from the vehicle, the behavior of the pedestrians (aggressive, calm, predictable, unpredictable, and the like), risk associated with driving within a vicinity of the vehicle, complexity associated with driving within of the vehicle, the presence (near the vehicle) of at least one out of a kindergarten, a school, a gathering of people, and the like. A contextual parameter may be related to the context of the sensed information-context may be depending on or relating to the circumstances that form the setting for an event, statement, or idea.

According to an embodiment, step 110 is followed by step 120 of processing, at a machine learning process of the computerized system, the sensed ground data in accordance with road object information samples collected at different points of time across the region of view and identifying, based on the processing, an occurrence of a road scenario deviation pertaining to the region of view.

According to an embodiment, the road scenario deviation is searched within a defined time window - for example within a day, within a week, within a month, within a time window that covers an event, and the like. Accordingly - the road scenario deviation is a deviation in comparison to the road scenarios experienced within the time window. For example - assuming that the time window is a weekday - then traffic during hours in which the traffic is much heavier than other hours (for example during rush hours) may form a road scenario deviation. Yet for another example - events such as the ending of a sport event within a vast stadium may provide a road scenario deviation, school zones during pickup or dropping times.

For example - the road scenario deviation may be defined using statistical terms - for example, the road scenario may have a metric of a value that deviates from a mean value of metrics by at least a defined distance - for example within 2, 3, 4, 5, 6, sigma.

According to an embodiment, the metric may represent at least one of vehicle density per area, average speed of vehicles and/or objects, and the like.

According to an embodiment, a metric of a road scenario deviation represents an obstacle, a traffic jam, a fire, an accident, and the like.

According to an embodiment, the road scenario deviation is associated with context such as the presence of an obstacle, a traffic jam, a fire, an accident, or any other road scenario deviation cause.

According to an embodiment, the context is searched regardless of any time window.

According to an embodiment, step 120 is followed by step 130 of selectively applying, in real-time in accordance with the identified occurrence of the road scenario deviation, an air coverage operation across the region of view, for use in autonomous driving in, at least in part, the region of view.

According to an embodiment, the air coverage operation includes issuing an instruction, or an indication notification, to a computerized system of the aerial system to provide aerial information across the road scenario deviation in the region of view. The instruction may be issued directly to the allocated aerial system. Additionally or alternatively, the instruction may be issued via a teleoperation system.

According to an embodiment this is selective allocation of drone(s) per dynamic changes of target areas - during inference. For example, for flying a drone that monitors the region of view and captures aerial data. For processing the aerial data. To be able to address the road scenario deviation (for example, in path planning or decision making) for autonomous driving.

According to an embodiment, step 130 is executed further in accordance with a teleoperation control system associated with the computerized system. The teleoperation control system is associated with and controls multiple aerial system. The computerized system executing method 100 is configured to request the teleoperation control system to allocate one or more aerial systems to provide air coverage related to the road scenario deviation.

According to an embodiment, step 130 is responsive to predicted and/or expected and current road scenario deviations - as the aerial systems are expected to cover all or at least some of the predicted and/or expected and current road scenario deviations. Any arbitration and/or allocations process may be provided. This may involve prioritizing road scenario deviation based on the potential damage they can impose and/or defined priorities, pseudo- random or ransom allocation, and the like.

According to an embodiment the allocation takes into account at least one of areas with dynamic changes of traffic like cities, junctions, roundabouts, the required air coverage - for example larger regions may require higher aerial systems.

According to an embodiment, the air coverage ends once the road scenario deviation ends or once the road scenario deviation is expected to end, or when there air coverage yields no or marginal benefits - once it is deemed that the road scenario deviation is about to end or once is it determined that road scenario deviation is properly managed.

According to an embodiment, the air coverage allocation operation is during the occurrence of the anomaly only. And may then further involve re-assessing the region of view, by processing new incoming sensed data of the region of view. And based on the re- assessing, determining whether to apply a verification operation or a subsequent driving related operation. For example, another air coverage allocation operation. Or for example, an operation to update the maps of the aerial system across the region of view, etc.

According to an embodiment step 130 involves allocating on-demand real-time coverage for redundancy/safety - drone per multiple vehicles (short sessions).

According to an embodiment step 130 involves using or requesting to use drone on ground available on demand to fly above certain area - this enables to increase update cycle of places that are not visited in high frequency for example upon receiving an alert about car accident, stuck truck, changes in the road setting like new lanes, construction

An identified road scenario is a known road scenario.

According to an embodiment, the air coverage operation is a temporary operation conditional on continuous identification of the occurrence of the road scenario deviation in real time.

According to an embodiment, the air coverage operation includes invoking extraction of aerial data pertaining to the region of view.

According to an embodiment, the air coverage operation includes invoking extraction of aerial data, such as satellite data. In cases where a satellite holds up-to-date satellite data over the region of view. For use of this up-to-date satellite data in learning of artificial intelligence models for autonomous driving.

According to an embodiment, step 130 is followed by step 140 of determining a path of driving for autonomous driving of a vehicle in the occurrence of the road scenario deviation.

According to an embodiment, the determining is based on at least one of the ground data obtained during step 110, information regarding the road scenario deviation, aerial information gathered during the air coverage operation, and the like. An example of path planning based on aerial information is illustrated in U.S. Patent Application No. 19/037,306 filed on Jan. 27, 2025 which is incorporated herein by reference.

According to an embodiment, step 140 includes applying one or more of the following path planning methods - Graph-Based Methods, Sampling-Based Methods, Optimization-Based Methods and/or Machine Learning-Based Methods. Graph-Based Methods include representing the environment as a graph and finds the shortest or most efficient path. For example - Dijkstra's Algorithm, A Algorithm* (An improved version of Dijkstra's, using a heuristic to guide the search), D Algorithm (Dynamic A)**, which adapts to dynamic environments by recalculating the path when obstacles change. Sampling-Based Methods are useful in high-dimensional or complex environments. They include a Rapidly- exploring Random Tree (RRT), and a Probabilistic Roadmap (PRM). Optimization-Based Methods aim to minimize cost functions, such as time, energy, or smoothness. They include Model Predictive Control (MPC), Artificial Potential Fields (APF), and Genetic Algorithms & Evolutionary Approaches. Machine Learning-Based Methods use data-driven approaches for learning path-planning strategies. They include Reinforcement Learning (RL),and Neural Networks for Imitation Learning.

According to an embodiment, step 140 is followed by transmitting the path planning to the one or more vehicles within the region (and maybe also outside the region - for example drive away from the region..) - using cellular communication or any other communication (satellite, using WiFi points, local communication devices) - such as communication listed in relation to method 100.

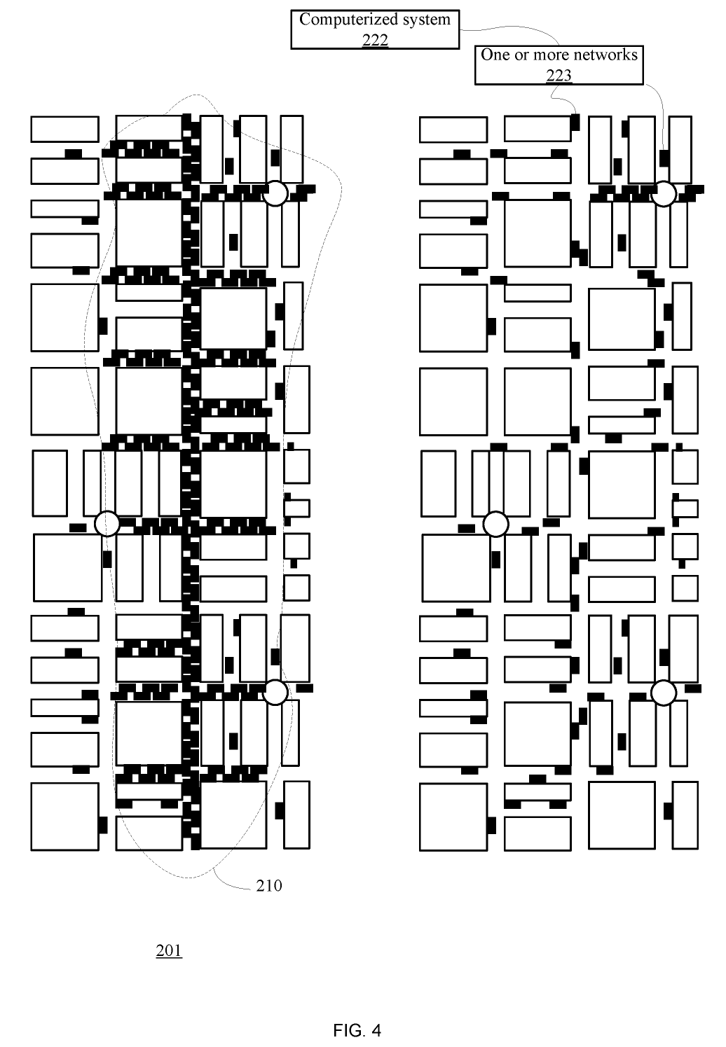

FIG. 4 illustrates an example of a region 201 without a road scenario deviation (right side of the image) and with a road scenario deviation 210 such as a traffic jam (left side of the image). The black boxes are vehicles. FIG. 4 also illustrates computerized system 222 configured to execute method 100 in communication via one or more networks 223 (including cellular and/or non-cellular- as illustrated in connection to method 100) with one or more vehicles and/or with an aerial system or a robotaxi service (not shown).

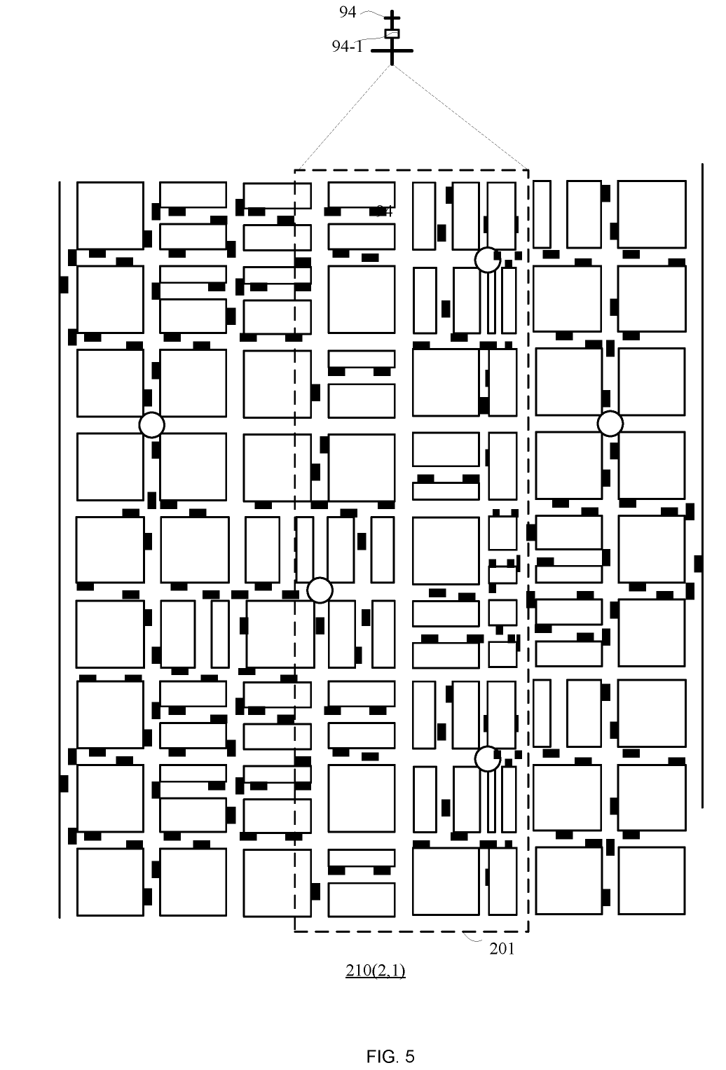

FIG. 5 illustrates a larger area 210(2,1) that includes region 201 and a drone 94 having a computerized system and a sensing unit (collectively denoted 94-1) for sensing aerial information, processing it and transmitting the sensing aerial information or metadata regarding the sensing aerial information to other systems.

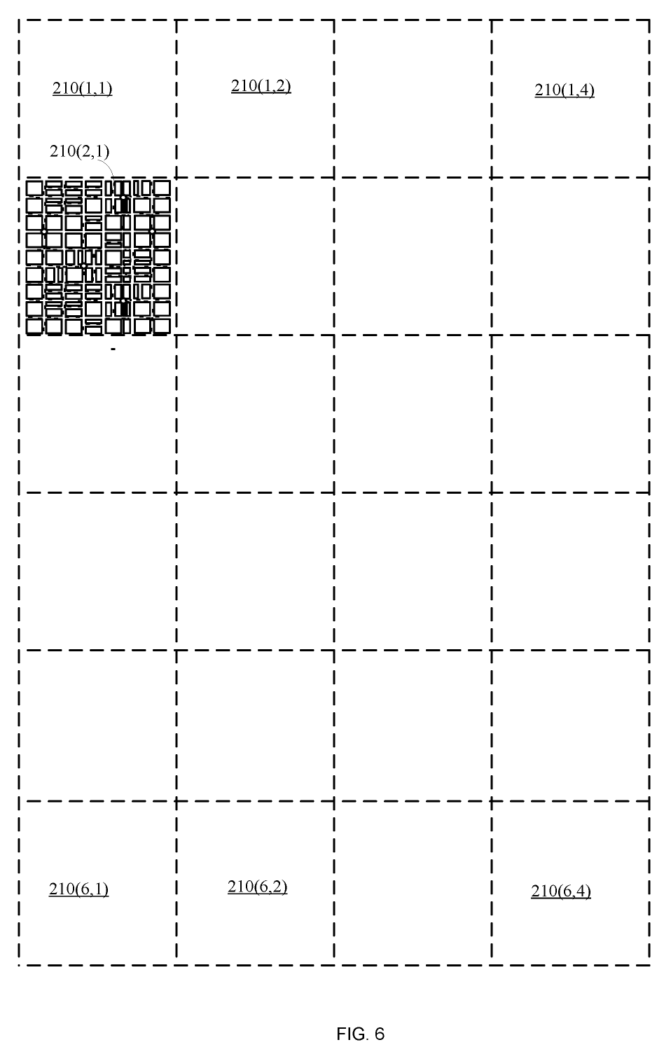

FIG. 6 illustrates multiple areas 210(1,1) - 210(6,4) that are allocated with a default air coverage scheme. The detection of the road scenario deviation 210 triggers a deviation from the default air coverage scheme - by directing an aerial system to cover region 201. For example- assuming that the drone should have covered area 210(6,4) when the road scenario deviation was detected - then it may be reallocated to cover the road scenario deviation.

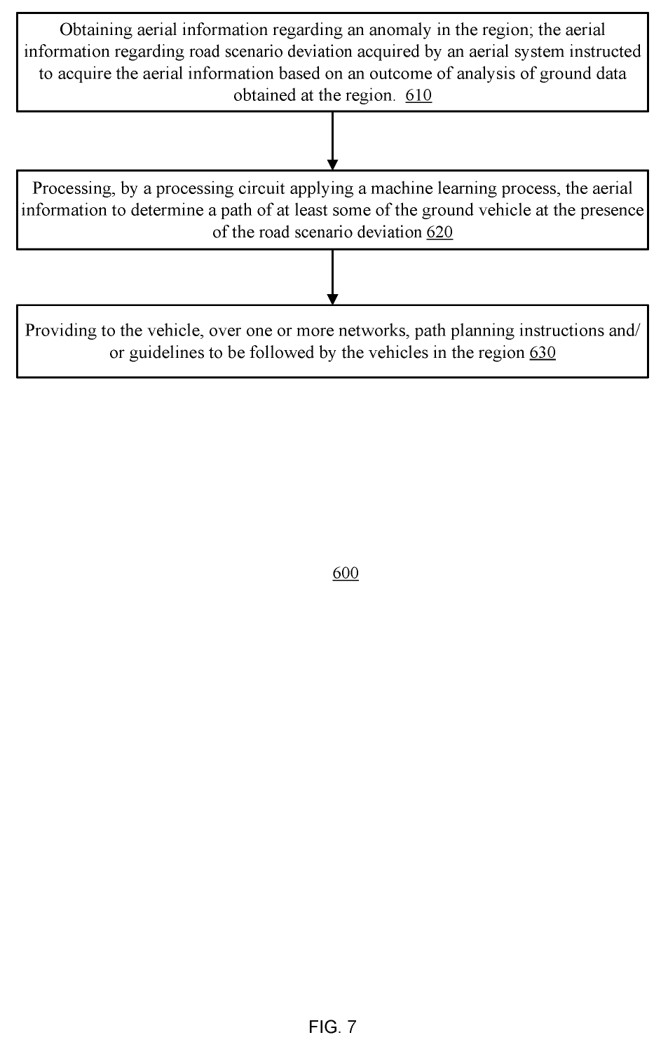

FIG. 7 illustrates method 600 for path planning related to an anomaly, the method.

According to an embodiment, method 600 includes step 610 of obtaining, by a computerized system in communication with multiple ground vehicles within a region, aerial information regarding a road scenario deviation in the region; the aerial information regarding the road scenario deviation being acquired by an aerial system instructed to acquire the aerial information based on an outcome of an analysis of ground data obtained at the region. According to an embodiment, step 610 used information generated following step 130.

According to an embodiment, step 610 is followed by step 620 of processing, by a processing circuit applying a machine learning process, the aerial information to determine a path of at least some of the ground vehicle at the presence of the road scenario deviation. According to an embodiment, step 620 includes applying one or more of the following path planning methods - Graph-Based Methods, Sampling-Based Methods, Optimization-Based Methods and/or Machine Learning-Based Methods. Graph-Based Methods includes representing the environment as a graph and finds the shortest or most efficient path. For example - Dijkstra's Algorithm, A Algorithm* (An improved version of Dijkstra's, using a heuristic to guide the search), D Algorithm (Dynamic A)**, which adapts to dynamic environments by recalculating the path when obstacles change. Sampling-Based Methods are useful in high-dimensional or complex environments. They include a Rapidly-exploring Random Tree (RRT), and a Probabilistic Roadmap (PRM). Optimization-Based Methods aim to minimize cost functions, such as time, energy, or smoothness. They include Model Predictive Control (MPC), Artificial Potential Fields (APF), and Genetic Algorithms & Evolutionary Approaches. Machine Learning-Based Methods use data-driven approaches for learning path-planning strategies. They include Reinforcement Learning (RL), and Neural Networks for Imitation Learning.

According to an embodiment, step 620 is followed by step 630 of providing to the vehicle, over one or more networks, path planning instructions and/or guidelines to be followed by the vehicles in the region.

According to an embodiment the path planning is sent to the one or more vehicles within the region - using cellular communication or any other communication (satellite, using WiFi points, local communication devices) - such as communication listed in relation to method 100.

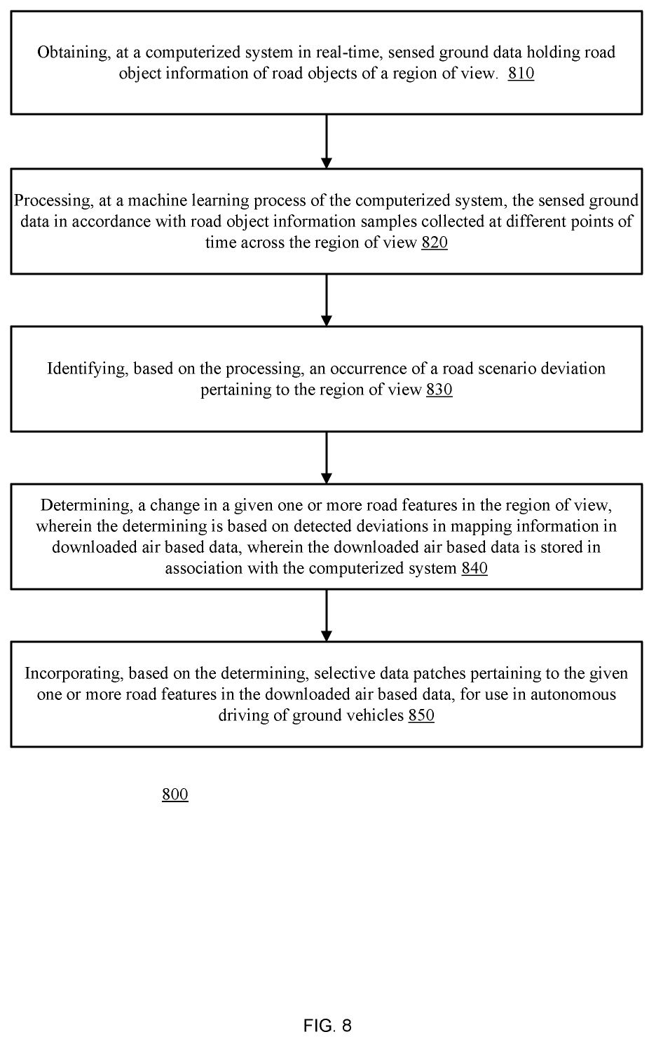

FIG. 8 illustrates an example of method 800 of incorporating road scenario deviation information in existing air based data for autonomous driving.

According to an embodiment, method 800 starts by step 810 of obtaining, at a computerized system in real-time, sensed ground data holding road object information of road objects of a region of view.

Step 810 is followed by step 820 of processing, at a machine learning process of the computerized system, the sensed ground data in accordance with road object information samples collected at different points of time across the region of view.

Step 820 is followed by step 830 of identifying, based on the processing, an occurrence of a road scenario deviation pertaining to the region of view.

Step 830 is followed by step 840 of determining, a change in a given one or more road features in the region of view, wherein the determining is based on detected deviations in mapping information in downloaded air based data, wherein the downloaded air based data is stored in association with the computerized system.

According to an embodiment step 840 relates to a driving related metric change pertaining to a new road feature in the region of view.

According to an embodiment step 840 relates to a driving related metric change pertaining to an existing road feature in the region of view.

Step 840 is followed by step 850 of incorporating, based on the determining, selective data patches pertaining to the given one or more road features in the downloaded air based data, for use in autonomous driving of ground vehicles.

According to an embodiment, step 850 includes at least one of: (a) updating data layer information stored in a database, (b) updating a plurality of different data layers stored in a database, each with a corresponding group of data patches pertaining to a different type of data layer, (c) updating at least a portion of a downloaded aerial imagery, (d) the incorporating is by using image registration of at least of: matching, scaling, and positioning of the selective data patches in the downloaded air based data (referring to the downloaded air based data is being stored in a cloud server - or elsewhere), (e) overlaying the downloaded air based data with the selective data patches (referring to the selective data patches - the selective data patches may be of the sensed ground data and/or may be extracted air based imagery data).

A way of updating and storing data layer information, by updating information in a database with updated road elements information is taught in U.S. Patent Application 18/739,321 entitled "Data Layer Augmentation" and filed on Jun. 11, 2024, which is incorporated herein by reference.

According to an embodiment there are multiple layers of information that are associated with each other. One or more data layers may differ each other by type (for example aerial information or aerial map versus ground level information or ground level map). One or more data layers may differ from each other by time of update or generation - for example patches may be generate more recently than maps. One or more layers may differ from each other by one or more parameter such as resolution, manner of representation (pixels, vectors, text, floating point numbers, fixed point numbers, filtered, unfiltered, compressed or non-compressed) and the like.

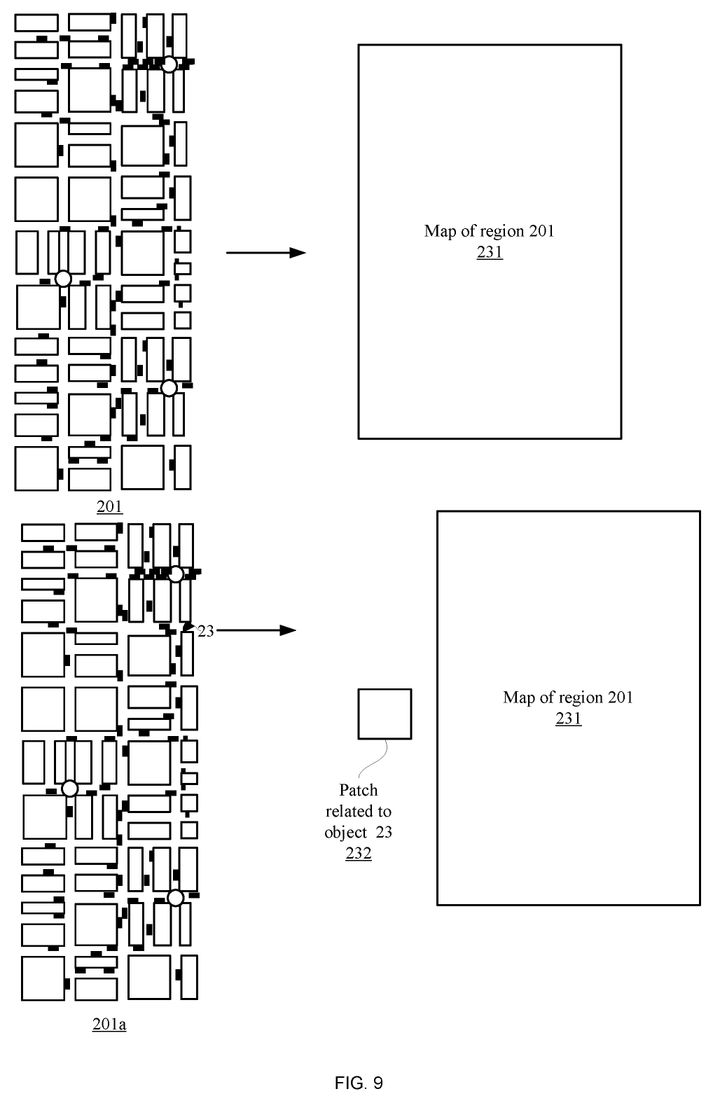

FIG. 9 illustrates an example of region 201 as captured at a first point in time and map (of region 201) 231. At a second point of time a new object (such as a pothole) 23 is identified (an example of a road scenario deviation) and a patch 232 related to the object is generated and associated with the map 231.

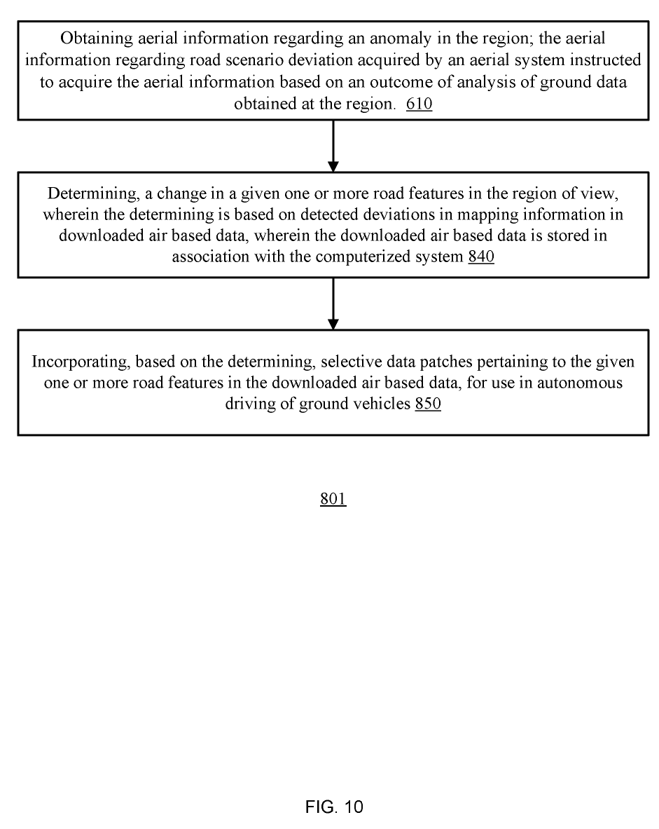

FIG. 10 illustrates method 801 for path planning related to an anomaly, the method.

According to an embodiment, method 801 includes step 610 of obtaining, by a computerized system in communication with multiple ground vehicles within a region, aerial information regarding a road scenario deviation in the region; the aerial information regarding the road scenario deviation being acquired by an aerial system instructed to acquire the aerial information based on an outcome of an analysis of ground data obtained at the region. According to an embodiment, step 610 used information generated following step 130.

Step 610 is followed by step 840 of determining, a change in a given one or more road features in the region of view, wherein the determining is based on detected deviations in mapping information in downloaded air based data, wherein the downloaded air based data is stored in association with the computerized system.

According to an embodiment step 840 relates to a driving related metric change pertaining to a new road feature in the region of view.

According to an embodiment step 840 relates to a driving related metric change pertaining to an existing road feature in the region of view.

Step 840 is followed by step 850 of incorporating, based on the determining, selective data patches pertaining to the given one or more road features in the downloaded air based data, for use in autonomous driving of ground vehicles.

According to an embodiment, step 850 includes at least one of: (a) updating data layer information stored in a database, (b) updating a plurality of different data layers stored in a database, each with a corresponding group of data patches pertaining to a different type of data layer, (c) updating at least a portion of a downloaded aerial imagery, (d) the incorporating is by using image registration of at least of: matching, scaling, and positioning of the selective data patches in the downloaded air based data (referring to the downloaded air based data is being stored in a cloud server - or elsewhere), (e) overlaying the downloaded air based data with the selective data patches (referring to the selective data patches - the selective data patches may be of the sensed ground data and/or may be extracted air based imagery data).

Because some aspects of the illustrated embodiments of the present disclosure may, for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any combination of any steps of any method illustrated in the specification and/or drawings may be provided. Any combination of any subject matter of any of claims may be provided. Any combinations of systems, units, components, processors, sensors, illustrated in the specification and/or drawings may be provided. Any combination of any module or unit listed in any of the figures, any part of the specification and/or any claims may be provided.

Any reference in the specification to a method should be applied mutatis mutandis to a device or system capable of executing the method and/or to a non-transitory computer readable medium that stores instructions for executing the method. Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

In the foregoing specification, the invention has been described with reference to specific examples of embodiments of the invention. It will, however, be evident that various modifications and changes may be made therein without departing from the broader spirit and scope of the invention as set forth in the appended claims. The specifications and drawings are, accordingly, to be regarded in an illustrative rather than in a restrictive sense.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Those skilled in the art will recognize that boundaries between the above- described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Any arrangement of components to achieve the same functionality is effectively "associated" such that the desired functionality is achieved. Hence, any two components herein combined to achieve a particular functionality may be seen as "associated with" each other such that the desired functionality is achieved, irrespective of the underlying architecture or intermedial components. Likewise, any two components so associated can also be viewed as being "operably connected," or "operably coupled," to each other to achieve the desired functionality.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

In the claims, any reference signs placed between parentheses shall not be construed as limiting the claim. The word 'comprising' does not exclude the presence of other elements or steps then those listed in a claim. Furthermore, the terms "a" or "an," as used herein, are defined as one or more than one. Also, the use of introductory phrases such as "at least one" and "one or more" in the claims should not be construed to imply that the introduction of another claim element by the indefinite articles "a" or "an" limits any particular claim containing such introduced claim element to inventions containing only one such element, even when the same claim includes the introductory phrases "one or more" or "at least one" and indefinite articles such as "a" or "an." The same holds true for the use of definite articles. Unless stated otherwise, terms such as "first" and "second" are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Thus, the scope of the embodiments of the disclosure is defined by the appended claims and equivalents thereof. While certain features of the disclosure have been illustrated and described herein, many modifications, substitutions, changes, and equivalents will now occur to those of ordinary skill in the art. It is therefore to be understood that the appended claims are intended to cover all such modifications and changes as fall within the true spirit of the invention.

We claim:

1. A method of multi-layered air coverage for autonomous driving, the method comprising:obtaining, at a computerized system in real-time, sensed ground data holding road object information of road objects of a region of view;processing, at a machine learning process of the computerized system, the sensed ground data in accordance with road object information samples collected at different points of time across the region of view;identifying, based on the processing, an occurrence of a road scenario deviation pertaining to the region of view; andselectively applying, in real-time in accordance with the identified occurrence of the road scenario deviation, an air coverage operation across the region of view, for use in autonomous driving in, at least in part, the region of view.

2. The method according to claim 1, wherein the air coverage operation includes issuing an instruction to a computerized system of the aerial system to provide aerial information across the road scenario deviation in the region of view.

3. The method according to claim 2, further comprising: processing, by a processing circuit, the aerial information; and determining, based on the processing, a path of driving for autonomous driving of a vehicle in the occurrence of the road scenario deviation.

4. The method according to claim 1, wherein the air coverage operation includes invoking extraction of aerial data pertaining to the region of view.

5. The method according to claim 1, wherein the obtaining is from one or more road vehicles in the region of view.

6. The method according to claim 1, wherein the obtaining is from a navigation system being in communication with the computerized system.

7. The method according to claim 1, wherein the obtaining is from a street view system.

8. The method according to claim 1, wherein the selectively applying is further in accordance with a teleoperation control system associated with the computerized system.

9. The method according to claim 1, wherein the determining is further in accordance with a set of metrics.

10. The method according to claim 1, wherein the occurrence of the road scenario deviation is a temporary scenario.

11. The method according to claim 10, wherein the air coverage operation is a temporary operation conditional on continuous identification of the occurrence of the road scenario deviation in real time.

12. A non-transitory computer readable medium for multi-layered air coverage for autonomous driving, the non-transitory computer readable medium storing instructions that, when executable by at least one processing device, cause the processing device to:obtain in real-time, sensed ground data holding road object information of road objects of a region of view;process, at a machine learning process of the computerized system, the sensed ground data in accordance with road object information samples collected at different points of time across the region of view;identify, based on the processing, an occurrence of a road scenario deviation pertaining to the region of view; andselectively apply, in real-time in accordance with the identified occurrence of the road scenario deviation, an air coverage operation across the region of view, for use in autonomous driving in, at least in part, the region of view.

13. The non-transitory computer readable medium according to claim 12, wherein the air coverage operation includes issuing an instruction to a computerized system of the aerial system to provide aerial information across the road scenario deviation in the region of view.

14. The non-transitory computer readable medium according to claim 13, wherein the stored instructions cause the processing device to: process, by a processing circuit, the aerial information; and determine, based on the processed aerial information, a path of driving for autonomous driving of a vehicle in the occurrence of the road scenario deviation.

15. The non-transitory computer readable medium according to claim 12, wherein the stored instructions cause the processing device to selectively apply the air coverage operation by invoking extraction of aerial data pertaining to the region of view.

16. The non-transitory computer readable medium according to claim 12, wherein the stored instructions cause the processing device to obtain the sensed ground data from one or more road vehicles in the region of view.

17. The non-transitory computer readable medium according to claim 12, wherein the stored instructions cause the processing device to obtain the sensed ground data from a navigation system being in communication with the computerized system.

18. The non-transitory computer readable medium according to claim 12, wherein the stored instructions cause the processing device to obtain the sensed ground data from a street view system.

19. The non-transitory computer readable medium according to claim 12, wherein the stored instructions cause the processing device to selectively apply the air coverage operation further in accordance with a teleoperation control system associated with the computerized system.

20. A system for multi-layered air coverage for autonomous driving, comprising:a memory configured to store sensed ground data holding road object information of road objects of a region of view; anda processor configured to:process, in real-time at a machine learning process, the sensed ground data in accordance with road object information samples collected at different points of time across the region of view;identify, based on the processed sensed ground data, an occurrence of a road scenario deviation pertaining to the region of view; andselectively apply, in real-time in accordance with the identified occurrence of the road scenario deviation, an air coverage operation across the region of view, for use in autonomous driving in, at least in part, the region of view.
